(19) United States
(12) Patent Application Publication
(10) Pub. No.: US 2004/0151627 A1
(43) Pub. Date: Aug. 5, 2004

(54) Methods for covalently attaching nucleic acids to substrates

(76) Inventors: Mary Anne Nelson, Albuquerque, NM (US); Gabriel P. Lopez, Albuquerque, NM (US); Yang Wu, Albuquerque, NM (US); Patricia L. Dolan, Albuquerque, NM (US); Robert L. Metzenberg, Northridge, CA (US)

Correspondence Address: JAGTIANI + GUTTAG, 10363-A DEMOCRACY LANE, FAIRFAX, VA, 22030, US

(21) Appl. No.: 10/643,871

(22) Filed: Aug. 20, 2003

Related U.S. Application Data
(63) Continuation-in-part of application No. 09/941,833, filed on Aug. 30, 2001.
(60) Provisional application No. 60/404,426, filed on Aug. 20, 2002.

(51) Int. Cl. G01N 1/10

(52) U.S. Cl. 422/58; 436/180

(57) ABSTRACT

The present invention provides a microarray comprising: a substrate comprising a diazotized substrate; and at least one polypeptide covalently bound to the diazotized substrate. The present invention also provides methods for making such a microarray.

### CROSS-REFERENCE TO RELATED APPLICATIONS

This application claims priority of U.S. Provisional Application No. Serial 60/404,426, entitled “Methods for Covalently Attaching Proteins to Substrates,” filed Aug. 20, 2002, and is a continuation-in-part of U.S. patent application Ser. No. 09/941,833, entitled “Methods for Covalently Attaching Nucleic Acids to Substrates,” filed Aug. 30, 2001. The entire contents and disclosures of which are hereby incorporated by reference.

### GOVERNMENT INTEREST STATEMENT

This invention is made with government support under Grant No. N00014-95-1315 and N00014-95-1-0901 from the Office of Naval Research to G.P.L. and Grant No. MCB-9874488 from National Science Foundation to M.A.N. The government may have certain rights in this invention.

### BACKGROUND OF THE INVENTION

1. Field of the Invention

The present invention relates generally to the field of means of attaching polypeptides to various substrates, including microarrays, silicon wafers, glass beads, glass slides, plastics, membranes, metals, or other irregular substrates and solutions containing particles with similar substrates.

2. Description of the Prior Art

Protein microarrays have been developed for high-throughput analysis of protein function (see Science, 289, 1760-1763). However, current technology leads to a problem of reusability. There is a need for increased uniformity and strength of attachment, which would result in more uniform fluorescent signals and decreased protein loss during the course of experiments. Also, if more stringent wash conditions were feasible, this could reduce background and thus allow for greater sensitivity. There is thus a need for increased reproducibility and consistency of results, and enhanced stability that allows the reuse of protein microarrays. None of the existing technologies provide a means to fulfill these needs.

### SUMMARY OF THE INVENTION

It is therefore an object of this invention to provide a means to attach polypeptides to substrates such as glass, silicon, and derivative substrate.

It is a further object of the present invention to provide a polypeptide microarray.

It is yet another object to provide a method for forming a polypeptide microarray.

It is yet another object to provide a polypeptide microarray that utilizes a glass or plastic substrate.

It is yet another object to provide a polypeptide microarray that utilizes a noble metal substrate.

It is yet another object to provide a polypeptide microarray that utilizes a metal oxide substrate.

It is yet another object to provide a washable polypeptide microarray that allows for repeated use.

In all of the above embodiments, it is an object to provide a microarray which covalently binds one or more polypeptides to a substrate.

According to a first broad aspect of the present invention, there is provided a microarray comprising: a diazotized tether group bound to a substrate; and at least one polypeptide covalently bound to the diazotized tether group.

According to a second broad aspect of the present invention, there is provided a method for forming a microarray comprising: (a) treating an oxidized surface of a substrate with a siloxy amine to form a siloxy amine treated substrate; (b) treating the siloxy amine treated substrate with a diazotizing agent to form a siloxy diazotized substrate; and (c) contacting the siloxy diazotized substrate with at least one polypeptide to form the microarray in which the at least one polypeptide is covalently bound to the siloxy diazotized substrate.

According to a third broad aspect of the present invention, there is provided a method for forming a microarray comprising: treating a noble metal substrate with a thiolate amine to form a thiolate amine treated substrate; treating the thiolate amine treated substrate with a diazotizing agent to form a thiolate diazotized substrate; and contacting the thiolate diazotized substrate with at least one polypeptide to form the microarray in which the at least one polypeptide is covalently bound to the thiolate diazotized substrate.

Other objects and features of the present invention will be apparent from the following detailed description of the preferred embodiment.

### BRIEF DESCRIPTION OF THE DRAWINGS

The invention will be described in conjunction with the accompanying drawings, in which:

FIG. 1 is a schematic diagram of the attachment of a tethered moiety to a solid substrate in accordance with a preferred embodiment of the present invention;

FIG. 2 is a schematic diagram of a primary aromatic amine (ATMS) diazotization method on a glass substrate in accordance with a preferred embodiment of the invention;

FIG. 3 is a schematic diagram of a primary aromatic amine diazotization method on a noble metal substrate in accordance with a preferred embodiment of the invention;

FIG. 4 is a schematic diagram illustrating the attachment of a polypeptide having a histidine terminal residue to the diazotized substrate of FIG. 2 in accordance with a preferred embodiment of the present invention;

FIG. 5 is a schematic diagram illustrating the attachment of a polypeptide having a tyrosine terminal residue to the diazotized substrate of FIG. 2 in accordance with a preferred embodiment of the present invention;

FIG. 6A is a scanned image of protein arrays of the present invention before FITC-Streptavidin incubation;

FIG. 6B is a scanned imaged of the protein arrays of FIG. 6A after FITC-Streptavidin incubation;

FIG. 7 is a graph illustrating quantitative results of the response of biotinylated BSA protein arrays of a preferred embodiment of the present invention to FITC-Streptavidin re-incubation;

FIG. 8A is a graphical plot of Cy5 intensity before and after Cy5-IgG Incubation versus increasing anti-IgG concentration for protein microarrays fabricated in accordance with a preferred embodiment of the present invention;

FIG. 8B is a graphical plot of Cy3 intensity before and after FITC-antiGFP Incubation versus increasing GFP concentration for protein microarrays fabricated in accordance with a preferred embodiment of the present invention;

FIG. 9A is a schematic diagram of an experiment to determine the orientation of His-tagged proteins on diazotized beads of the present invention;

FIG. 9B is a graph of fluorescence for the beads prepared in the experiment of FIG. 9A; and

FIG. 10 is a graph comparing diazotized and amine terminated glass beads contacted with 6×His-tagged GFP under different pH environments detected with FITC-antiGFP.

### DETAILED DESCRIPTION OF THE PREFERRED EMBODIMENT

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention the term “polypeptide” refers broadly to all types of polypeptides and conjugated polypeptides including: proteins, protein sequences, amino acid sequences, denatured proteins, antigens, oncogenes, portions of oncogenes, etc.

For the purposes of this invention, the term “microarray” refers to a device that employs the attachment of biomolecules, such as polypeptides, to a substrate.

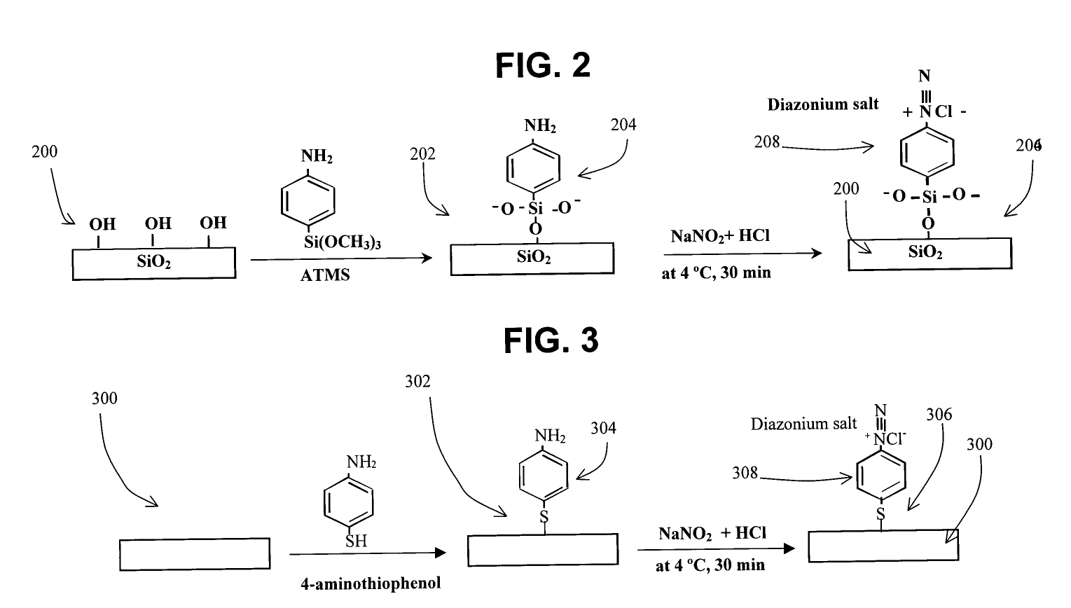

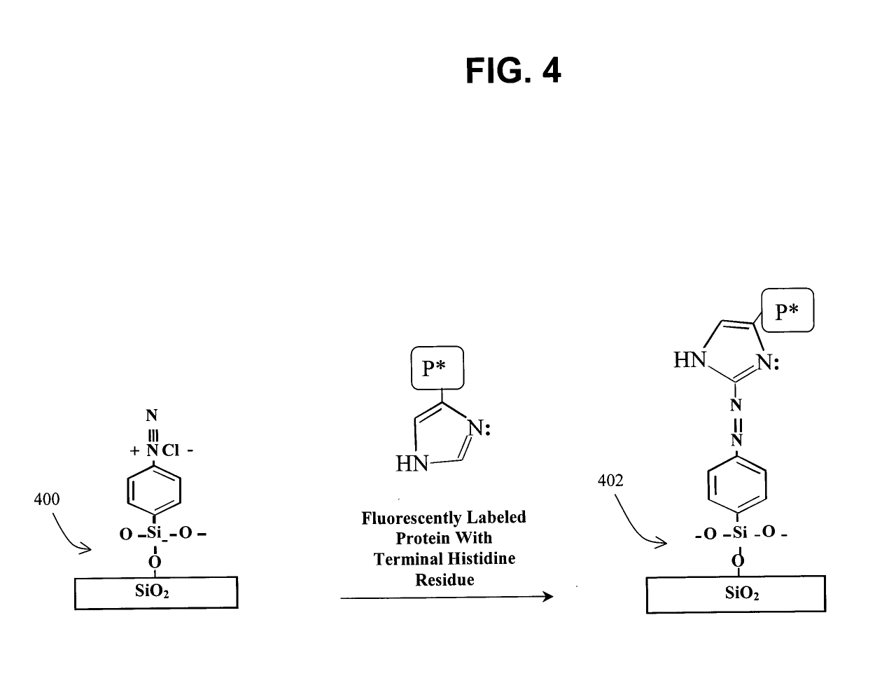

For the purposes of this invention, the term “tether group” refers to an aromatic amine compound that binds to a substrate. Examples of tether groups are siloxy amine group 204 and thiolate amine group 304 shown in FIGS. 2 and 3, respectively.

For the purposes of this invention, the term “diazotized tether group” refers to a tether group wherein a diazonium group is substituted for the amine of a tether group. Examples of diazotized tether groups are siloxy diazotized group 208 and thiolate diazotized group 308 shown in FIGS. 2 and 3, respectively.

For the purposes of this invention, the term “siloxy diazotized substrate” refers to a substrate, such as siloxy diazotized substrate 206 in FIG. 2, in which one or more siloxy diazotized groups are bound to the substrate.

For the purposes of this invention, the term “oxidized surface” refers to an oxygen containing surface (e.g. of a metal oxide or one that has been treated with an oxidizing agent) of a substrate that it is reactive with a siloxy amine.

For the purposes of this invention, the term “siloxy amine treated substrate” refers to a substrate to which is bound one or more siloxy amines.

For the purposes of this invention, the term “thiolate diazotized substrate” refers to a substrate, such as shown by diazotized noble metal substrate 306 in FIG. 3, in which one or more thiolate diazotized groups are bound to the substrate.

For the purposes of this invention, the term “thiolate amine treated substrate” refers to a substrate to which is bound one or more thiolate amines.

For the purposes of this invention, the term “noble metal substrate” refers to noble metal used in the microarray that attaches to 4-aminothiophenol with thiolate groups.

For the purposes of this invention, the terms “diazotized” or “diazotizing” refers to converting the amine of a tether group to a diazonium ion.

For the purposes of this invention, the term “diazotizing agent” refers to a reagent for diazotizing an amine of a tether group. Preferred diazotizing agents include mixtures containing nitrous acid. FIGS. 2 and 3 illustrate the use of NaNO₂ and HCl as the diazotizing agent.

For the purposes of this invention, the term “siloxy amine” refers to a primary aromatic amine such as ATMS or similar compound that attaches to the silanol groups of a substrate, such as a glass substrate.

For the purposes of this invention, the term “thiolate amine” refers to a primary aromatic amine such as 4-aminothiophenol or similar compound that attaches to a substrate, such as a noble metal substrate.

For the purposes of this invention, the term “ATMS” refers to p-aminophenyl trimethoxysilane.

For the purposes of this invention, the term “free polypeptide” refers to a polypeptide that is not covalently bound to a substrate or attached to a bound polypeptide.

For the purposes of this invention, the term “bound polypeptide” refers to polypeptides covalently bound to a substrate.

For the purposes of this invention, the term “stripping” refers to the removal of a hybridized or attached polypeptide on a microarray.

For the purposes of this invention, the term “silanol group” refers to a hydroxy group bound to silicon.

For the purposes of this invention, the term “aptamers” refers to non-immunogenic compounds that bind to targets with high affinity and specificity.

For the purpose of the present invention, the term “terminal residue” refers to the conventional meaning of the term terminal residue with respect to polypeptides i.e. an amino acid residue at the end of a polypeptide chain.

For the purpose of the present invention, the term “terminal series” refers to a series of consecutive residues at the end of a polypeptide chain, such as a series of 6 histidine or 6 tyrosine residues. For example, the term “6×His” refers to a terminal series of 6 histidine residues.

For the purposes of the present invention, the term “internal residue” refers to the conventional meaning of term terminal residue with respect to polypeptides and refers to a residue that is not a terminal residue nor a part of a terminal series of residues.

For the purposes of the present invention, the term “powerful electron-releasing group” refers to the following powerful electron releasing groups: —OH, —O⁻, —NR₂, —NHR, or —NH₂.

For the purposes of this invention, the term “biomolecule” refers to nucleic acids, modified RNA, aptamers, proteins, polypeptides, including antibodies and fragments thereof, and similar or related chemical compounds.

### Description

The present invention relates broadly to the attachment of polypeptides, such as proteins, to various substrates, which include microarrays, silicon wafers, glass beads, glass slides, plastics, membranes, metals, or other irregular substrates and solutions containing particles with similar substrates. While the chemistry described hereinafter applies to the attachment of polypeptides to any of these substrates, the remaining discussion will focus on the preferred embodiment of attaching polypeptides to a glass slide to create a microarray.

The present invention produces a chemically reactive surface on substrates to which a polypeptide may covalently bind. Subsequently, the immobilized polypeptide may be exposed to a variety of biomolecules in a reproducible, consistent, uniform and stable manner. Depending on the application, the immobilized polypeptide or the biomolecule to be interacted with the immobilized polypeptide may be fluorescently labeled. The covalent binding of polypeptides to solid substrates should increase the uniformity of attachment, and result in more uniform fluorescent signals and decreased polypeptide loss during the course of experiments. Covalently bound polypeptides also permit the use of more stringent wash conditions, which reduces background and thus allows for greater sensitivity. The binding chemistry involved in the present invention provides increased reproducibility and consistency of results, and enhanced stability that allows the reuse of microarrays. In addition, this chemistry does not require prior synthetic modification of polypeptides, although such modifications may be made to allow the polypeptides to bind to the substrate. For example, a terminal series of histidine residues may be added to the end of a polypeptide being studied to insure proper binding of the polypeptide to a substrate. Standard procedures involving proteins and/or other polypeptides, such as specific ligand-receptor or other protein binding, or polymerase chain reaction, may be performed on the microarrays of the present invention.

As discussed earlier, the lack of reusability of current polypeptide arrays presents a big problem, but a substrate that allows covalent attachment of polypeptides may solve the problem of reusability. The derivatization method of the present invention to covalently immobilize polypeptides onto a glass substrate for subsequent experimentation with the polypeptides can solve problems with the prior art. The present invention produces a chemically reactive surface on a substrate to which polypeptides will covalently bind and, subsequently, retain the biological activity of free polypeptides. The present invention involves a method for covalently linking proteins and other polypeptides to a substrate in a manner that preserves the ability of the immobilized polypeptide to behave similarly to the way that a free polypeptide behaves in terms of binding with antigens, enzyme activity, etc.

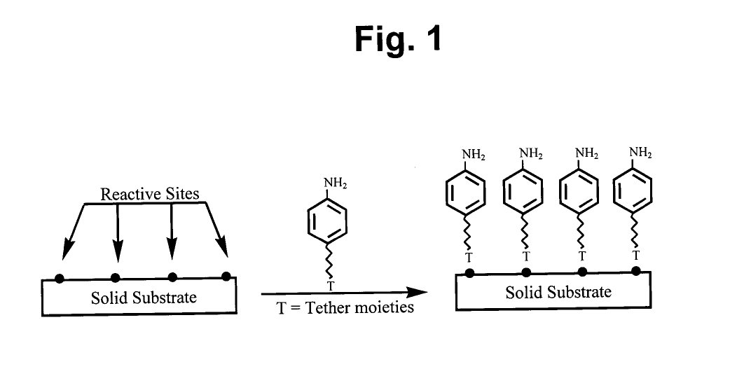

FIG. 1 illustrates the attachment of a tethered moiety to a solid substrate in accordance with a preferred embodiment of the present invention. The method of the present invention may be used to attach polypeptides to a wide variety of substrates, including: silicon wafers, glass beads, glass slides, plastics, membranes, metals, or other irregular substrates and solutions containing particles with similar substrates. Depending on the type of substrate, different methods may be employed to attach an amine moiety to the substrate that has been diazotized to allow for the binding of the polypeptide to the substrate.

In a preferred embodiment of the present invention, the process of binding polypeptides to the substrate may be repeated several times by adding polypeptides to the diazotized substrate and “stripping” (removing) polypeptides that do not bind to the diazotized substrate.

The surface chemistry of the substrates of the present invention description is based on the diazotization of aromatic amine substrates. Suitability of the solid substrate involves the presence of a suitable tether that is used to attach aromatic amine moieties. Examples of tether moieties include, but are not limited to trialkoxy or trichloro silanes for immobilization to oxide substrates (e.g., glass) or thiols for immobilization on noble metal (e.g. Au, Ag, Cu) substrates. FIG. 1 shows a schematic of the attachment of a tethered moiety to a solid substrate. FIG. 1 shows a tether group that attaches to a reactive site on the solid substrate. Once the tether group reacts with the solid substrate, FIG. 1 shows that the amine group is available for reaction with NaNO₂ and HCl to form the diazonium ion as illustrated in FIGS. 2 and 3 and described below.

FIG. 2 illustrates in schematic form a method for producing a diazotized glass substrate of the present invention. A glass substrate 200 is washed and oxidized with piranha solution and functionalized with p-aminophenyl trimethoxysilane (ATMS) to form the siloxy amine treated substrate 202 having a bound siloxy amine group 204. Siloxy amine treated glass substrate 202 is then treated with a solution containing hydrochloric acid (HCl) and sodium nitrite (NaNO₂) to form a diazotized glass substrate 206 in a which siloxy diazonium group 208 comprising a p-diazoniumphenyltrimethoxysilane salt is attached to glass substrate 200.

Preferably the diazotized glass substrate is formed from the siloxy amine treated glass substrate by exposing the siloxy amine treated substrate with up to 300 mM NaNO₂, more preferably 5.2 mM NaNO₂ and up to 2 M HCl, 0.26 M HCl at 0-25° C., more preferably 0-15° C., even more preferably 0-4° C. Preferably the siloxy amine treated glass substrate is exposed to NaNO₂ and HCl for 10-30 minutes, more preferably 30 minutes. In a preferred embodiment, the diazotized glass substrate is formed from the siloxy amine treated glass substrate by exposing the siloxy amine treated substrate with 3.7 mM NaNO₂ and 1.17 M HCl at 0-4° C. for 30 minutes.

FIG. 3 illustrates in schematic form a method for producing a diazotized noble metal substrate of the present invention. A noble metal substrate 300 is washed and functionalized with 4-aminothiophenol to form thiolate amine treated substrate 302 having bound a thiolate amine group 304. FIG. 3 then illustrates that the thiolate amine treated substrate 302 is treated with a solution containing hydrochloric acid (HCl) and sodium nitrite (NaNO₂) to form a diazotized noble metal substrate 306 in which a thiolate diazonium group 308 comprising a p-diazoniumthiophenol salt is attached to noble metal substrate 300.

Preferably the diazotized noble metal substrate by exposing the thiolate amine treated noble metal substrate with up to 300 mM NaNO₂, more preferably 5.2 mM NaNO₂ and up to 2 M HCl, 0.26 M HCl at 0-25° C., more preferably 0-15° C., even more preferably 0-4° C. Preferably the thiolate amine treated noble metal substrate is exposed to NaNO₂ and HCl for 10-30 minutes, more preferably 30 minutes. In a preferred embodiment, the diazotized glass substrate is formed from the thiolate amine treated noble metal substrate by exposing the thiolate amine treated noble metal substrate with 3.7 mM NaNO₂ and 1.17 M HCl at 0-4° C. for 30 minutes.

The present invention provides a chemical process for covalently linking polypeptides to a substrate in a manner that preserves the ability of the immobilized polypeptide to interact with other molecules and carry out enzymatic reactions. In a preferred embodiment, glass substrates are first cleaned and oxidized with piranha solution and then functionalized with p-aminophenyl trimethoxysilane (ATMS).

Before covalently bonding a target polypeptide to a glass substrate, ATMS-reacted substrates are preferably converted to the benzene diazonium form by treatment with a solution containing HCl and NaNO₂ as illustrated in FIG. 2. Primary aromatic amines react with nitrous acid to yield diazonium salts. In this step, an electrophilic attack by ⁺NO causes displacement of the H⁺ at the nitrogen (Organic Chemistry, (Third ed.) 1973):

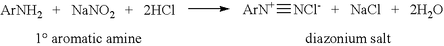

Because diazonium salts are unstable, this and all subsequent steps of this process, inclusive of nucleic acid, biomolecule or polypeptide spotting, are preferably performed at 4° C. After 30 minutes, the ATMS-treated substrates are preferably washed successively with ice-cold sodium acetate buffer, double-distilled H₂O, and 100% ethanol. A gentle acidic buffer keeps the diazonium salts active (Organic Chemistry, (Third ed.) 1973) on the glass substrate.

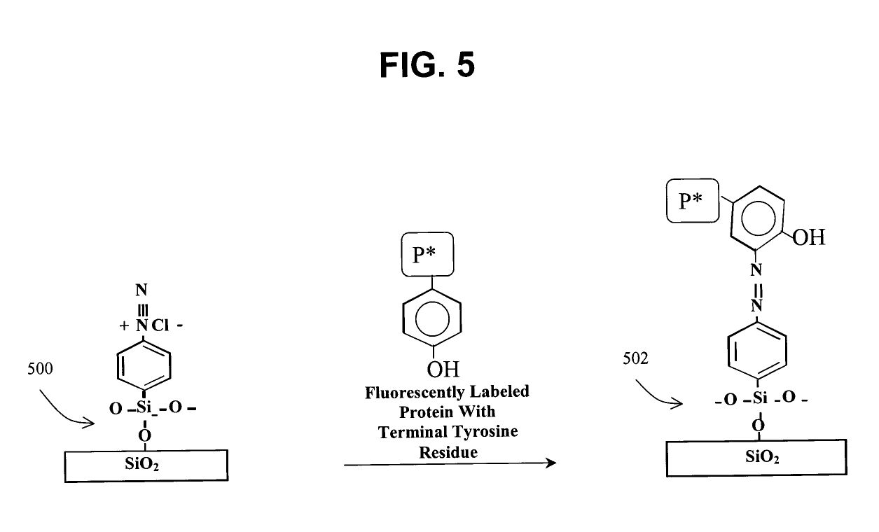

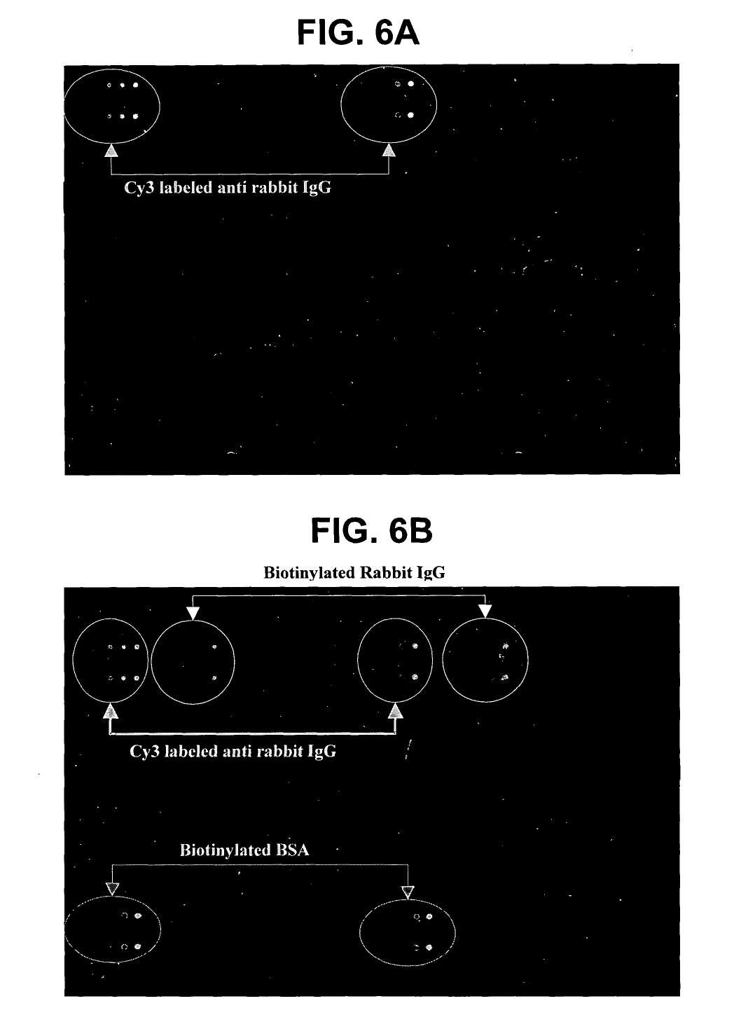

In a preferred embodiment of the present invention, as illustrated in FIGS. 4 and 5, polypeptides may be spotted or microarrayed onto the diazotized glass substrate produced by the process of FIG. 3 and air-dried at room temperature for 1-2 hours. The polypeptide reacts to form a covalent bond with the azo-terminus of the diazotized substrate (Organic Chemistry, (Third ed.) 1973). In order to neutralize unreacted diazonium groups and to reduce nonspecific binding of the polypeptide to the slide, the substrates are preferably immersed in 1% glycine solution or up to 5% BSA solution.

Diazonium salts can undergo a reaction referred to as “coupling,” in which certain aromatic compounds covalently bind to the positively-charged nitrogen of the diazonium group (Organic Chemistry, (Third ed.) 1973). In the reaction between the diazonium salt on the glass substrate and the polypeptide, any aromatic rings of the polypeptide undergo attack by the diazonium ion. Because the diazonium ion is very weakly electrophilic, the aromatic ring preferably contains a powerful electron-releasing group, i.e., —OH, —O⁻, —NR₂, —NHR, or —NH₂. Covalent binding usually occurs para to the activating (electron-releasing) group (Organic Chemistry, (Third ed.) 1973).

Although only the process for forming a diazotized glass substrate is described in detail above, the present invention can utilize a variety of substrates. With the exception of noble metal substrates and aromatic polyamide substrates (which may still contain aromatic amine monomers following polymerization and, as such, can possibly undergo diazotization directly), primary aromatic amines are generally introduced to oxidized substrates, e.g., silica and plastic, by silanization, as shown above for glass. Hydroxyl groups are added to these substrates by surface oxidation reactions. For example, silicon may be treated with an oxidizing agent such as piranha solution similar to piranha solution described above for glass. Polymers, e.g. plastics, can be oxidized by a variety of oxidation techniques including the use of corona discharge, ozone, oxygen plasma, hydrogen peroxide, nitrous acid, alkaline hypochlorite, UV irradiation, oxidizing flame, and chromic acid (Polymer Science and Technology, R. Ebewele, 2000; Journal of Adhesion, 43 (#1-2), 139-155, 1993; Journal of Micromech. Microeng., 9, 211-217, 1999; Appl. Phys. Let., 75(#17), 2557-2559, 1999; Langmuir, 14, 5586-5593, 1998; Journal of Adhesion Sci. Tech., 11(#7), 995-1009, 1995; Syn. Metals, 60(#2), 93-96, 1993). Gutowski et al., (Journal of Adhesion, 43 (#1-2), 139-155, 1993) used the process of corona discharge followed by application of organo-functional silane to accomplish the silanization of polyethylene. The incorporation of surface hydroxyl groups onto the polymer substrate enables organo-silane to create the hydrogen or covalent bonds with the oxidized polymer substrate. Whitesides et al. (Journal of Micromech. Microeng., 9, 211-217, 1999; Appl. Phys. Let., 75(#17), 2557-2559, 1999) have successfully accomplished the oxidation of different substrates (polymer, glass, silicon, silicon oxide) through oxygen plasma. Fadeev and McCarthy'sresearch (Langmuir, 14, 5586-5593, 1998) shows that a 3-aminopropyltrialkoxysilanes modified polyethylene terephthalate (PET) substrate followed by hydrolysis is reactive to organosilanes and should react with the versatility of oxidized silicon wafers. Recent research also shows that silane can be used in modifying clay and ceramic (Appl. Clay Sci., 15(#1-2), 51-65, 1999; Ceramic Int., 21(#3), 181-186, 1995). Thus, based on the theory and results of recent researches, hydroxyl group terminated surfaces may include oxidized glass, oxidized silica substrate, and oxidized polymer. Clay and ceramic are able to be modified by silane. Glass, silicon wafer, polymers such as plastics, clay and ceramic are thus all suitable substrates for the present invention after the pre-treatment of oxidization.

FIG. 4 illustrates the covalent binding of a fluorescently labeled polypeptide with a terminal histidine residue to a diazotized glass substrate 400 of the present invention to form a microarray 402. As can be seen in FIG. 4, histidine preferentially attaches to the diazonium group of diazotized glass substrate 400 on the ring carbon between the two N groups of the histidine. That histidine will form a covalent compound with diazonium salts has been previously demonstrated in Curreli et al. (Journal of Applied Polymer Science, 66(#8), 1433-1438, 1997). Although only a single terminal histidine residue is shown in FIG. 4, the polypeptides of the present invention preferably include a terminal series of 6 histidine residues and may include terminal series of as many as 20 histidine residues to aid in the binding of the polypeptide to the diazonium group. Methods of attaching such “polyhistidine groups” are well known in the art and are described for example in Fancy et al. (Chemistry & Biology, 3(#7), 551-559, 1996).

Although FIG. 4 illustrates using a terminal histidine residue to bind a polypeptide to a diazotized substrate of the present invention, the present invention also encompasses polypeptide being bound to diazotized substrates using an internal histidine residue.

FIG. 5 illustrates the covalent binding of a fluorescently labeled polypeptide with a terminal tyrosine residue to a diazotized glass substrate 500 of the present invention to form a microarray 502. As can be seen in FIG. 5, tyrosine preferentially attaches to the diazonium group of diazotized glass substrate 500 on the ring carbon that is ortho to the hydroxy group of tyrosine. That tyrosine will form a covalent compound with diazonium salts has been previously demonstrated in Curreli et al. (Journal of Applied Polymer Science, 66(#8), 1433-1438, 1997). Although only a single terminal tyrosine residue is shown in FIG. 5, the polypeptides of the present invention preferably include a terminal series of 6 tyrosine residues and may include terminal series of as many as 20 tyrosine residues to aid in the binding of the polypeptide to the diazonium group. Methods of attaching such “polytyrosine groups” are well known in the art and are described for example in Fancy et al. (Chemistry & Biology, 3(#7), 551-559, 1996).

Although FIG. 5 illustrate using a terminal tyrosine residue to bind a polypeptide to a diazotized substrate of the present invention, the present invention also encompasses a polypeptide being bound to diazotized substrates using an internal tyrosine residue.

Although FIGS. 4 and 5 illustrate binding a polypeptide to a diazotized glass substrate, procedures similar to those illustrated in FIGS. 4 and 5 may be used to bind a polypeptide to other types of substrates such as a noble metal substrate or a plastic substrate.

Although FIGS. 3 and 4 illustrate using terminal histidine and tyrosine residues to bind a polypeptide to a diazotized substrate of the present invention, the present invention also encompasses polypeptides being bound to diazotized substrates using internal histidine or residues of the polypeptides.

Although one type of polypeptide is shown being bound to the substrate in the polypeptide arrays of FIGS. 4 and 5, the present invention envisions two or more different types of polypeptides being part of a single array of polypeptides or two different arrays of polypeptides being bound to the same substrate, such as a slide.

The substrate of the present invention may have any size or shape. In a preferred embodiment, the substrate has a thickness of approximately 1 mm.

The present invention will now be described by way of example.

### EXAMPLE 1

ATMS-reacted surfaces were converted to the diazobenzyl form by treatment with a solution containing 40 ml of water, 80 ml of 400 mM HCl, and 3.2 ml of freshly prepared solution of NaNO₂ (200 mM) for 30 minutes at 4° C.

### EXAMPLE 2

Method for Diazotizing Glass, Plastic, and Other Substrates. Glass or silicon substrates requiring a pre-oxidation step were cleaned by immersion into piranha solution (70/30 v/v sulfuric acid and 30% hydrogen peroxide) for 30 minutes followed by washing in deionized water (Langmuir, 12, 4621-4624, 1996). Cleaned substrates were coated with ATMS by immersing the substrates in 1 mM solution of p-aminophenyl trimethoxysilane in ethanol for 30 minutes. The substrates were then rinsed in ethanol and dried in a stream of N₂. This procedure resulted in the formation of an amine-terminated layer on the substrate. Formation of silane layers was confirmed by X-ray photoelectron spectroscopy. The thickness of the ATMS layers was estimated by ellipsometry of monolayers formed on substrate-oxidized Si wafers (Langmuir, 12, 4621-4624, 1996). The ellipsometric thickness of this ATMS layer was 4.9±0.2 Å.

The diazotization of ATMS-treated substrates in this example was done as follows. Just before reaction with nucleic acids, ATMS-reacted substrates were converted to the benzene diazonium form by treatment with a solution containing 120 ml of water, 240 ml of 400 mM HCl, and 9.6 ml of freshly prepared solution of 200 mM NaNO₂ for 30 minutes at 4° C. (Alwine et al., Proc. Natl. Acad. Sci. USA, 74, 5350-5354, 1977). After 30 minutes, the ATMS-treated substrates were washed 3 times, each for 3 minutes, with ice-cold sodium acetate buffer (50 mM, pH 4.7) followed by washing with ice-cold deionized water and then ethanol 2 times each (5 minute washes). The diazotized substrates were air-dried and gently blotted with Kimwipes™ (Kimberly-Clark, GA) while maintaining their temperature at 4° C.

The preceding method of layer formation of siloxy amines and diazotization of siloxy amine treated substrates can be applied to other oxidized substrates such as, plastics, clay, ceramics, and membranes. Though the diazonium salts on the glass substrate are unstable and, thus, remain optimally active at a temperature of 4° C., the diazotized substrate will remain significantly, though less, active for hours at room temperature. Correspondingly, while covalent attachment of polypeptides is optimal at 4° C., covalent attachment will occur at room temperature for hours following diazotization of the substrate. In certain cases such use of higher temperatures may be more practical and the resulting attachment is acceptable. Additionally, the reaction will work, at least partially, for incubation times less than 30 minutes with acceptable but less than optimal results. It may also be possible to use common salts, such as ZnCl₂, as stabilizers of the diazonium ions, which may ameliorate the decreased attachment and annealing performance at temperatures above 4° C. Such procedures are also anticipated by this invention.

### EXAMPLE 3

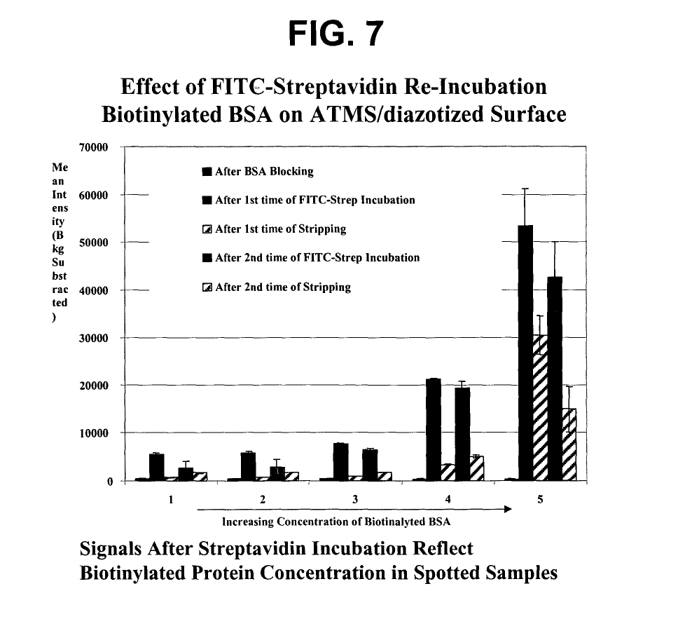

FIG. 6A is a scanned image of protein arrays of the present invention bound to a glass slide. Each of the proteins in the arrays is bound to the slide using histidine and/or tyrosine residues present in the proteins. On the slide there are bound arrays of Cy3 (a fluorescent dye) labeled anti rabbit IgG protein, indicated by the encircled regions labeled “Cy3 labeled anti rabbit IgG”. The spots of the arrays in these labeled regions have different intensities due to the concentration of IgG in each of the spots. Also on the slide of FIG. 6A are bound arrays of biotinylated rabbit IgG protein, rabbit IgG to which biotin has been bound. In addition, on the slide are arrays of biotinylated BSA (Bovine Serum Albumin) protein, BSA to which biotin has been bound. The biotinylated rabbit IgG and biotinylated BSA arrays are not visible in FIG. 6A, because these arrays are not fluorescently labeled.

FIG. 6B illustrates the results of incubating the protein arrays of FIG. 6A with FITC (Fluorescein-Isothiocyanate, a fluorescent label) labeled Streptavidin. In FIG. 6B, in the biotinylated rabbit IgG arrays, indicated by the encircled regions labeled “Biotinylated rabbit IgG), fluorescence intensity due to FITC is visible in the spots of the arrays. Because Streptavidin is a protein that tightly binds to the vitamin biotin, the presence of FITC in these spots indicates that FITC-Streptavidin has bound to the biotinylated rabbit IgG. Also, in the biotinylated BSA arrays, indicated by the encircled regions labeled “Biotinylated BSA”, fluorescence intensity due to FITC is visible in the spots of the arrays, indicating that FITC-Streptavidin has bound to the biotinylated BSA.

The fact that the FITC-Streptavidin bound to the biotinylated rabbit IgG and BSA shows that the biotinylated rabbit IgG and BSA proteins retain their protein activity after being bound to the glass slide.

The protein arrays of FIG. 6A were prepared using the following procedure. Glass microscope slides were precleaned by piranha solution for 30 minutes, rinsed with dH₂O and ethanol, dried under N₂ stream. The slides then functionalized by immersed into 3 mM ATMS in either ethanol or toluene solution for 3 hrs, followed by rinsing with ethanol and water. ATMS coated slide were then diazotized in 4° C. diazotization solution comprising 5.2 mM NaNO₂ and 0.2M HCl for 30 minutes, washed by 3×3 mins of NaOAc buffer (50 mM NaOAc, use HAc or NaOH bring pH=4.7), 2×5 mins of dH2O and 2×5 mins of ETOH all at 4° C. right before array formation. Protein microarrays were printed by a commercialized microarrayer at room temperature and promptly moved to a humid chamber, incubated for 2 hrs, and blocked by 1% BSA solution.

The protein arrays of FIG. 6B were incubated with FITC-Streptavidin by reacting with 0.4 mM of FITC-Streptavidin under a glass coverslip in a humid chamber at room temperature for 2 hrs, followed by 1×SSC+0.1% SDS, 0.1×SSC+0.1% SDS, 0.1×SSC, and dH₂O wash. The glass slide of FIG. 6B was subsequently stripped using an alkali stripping solutions comprising 2.5 mM Na₂HPO₄+0.1% SDS heated to 95° C. to remove proteins, i.e. FITC-Streptavidin, that did not covalently attach to the protein arrays. After stripping, the glass slide was reincubated with FITC-Streptavidin a second time.

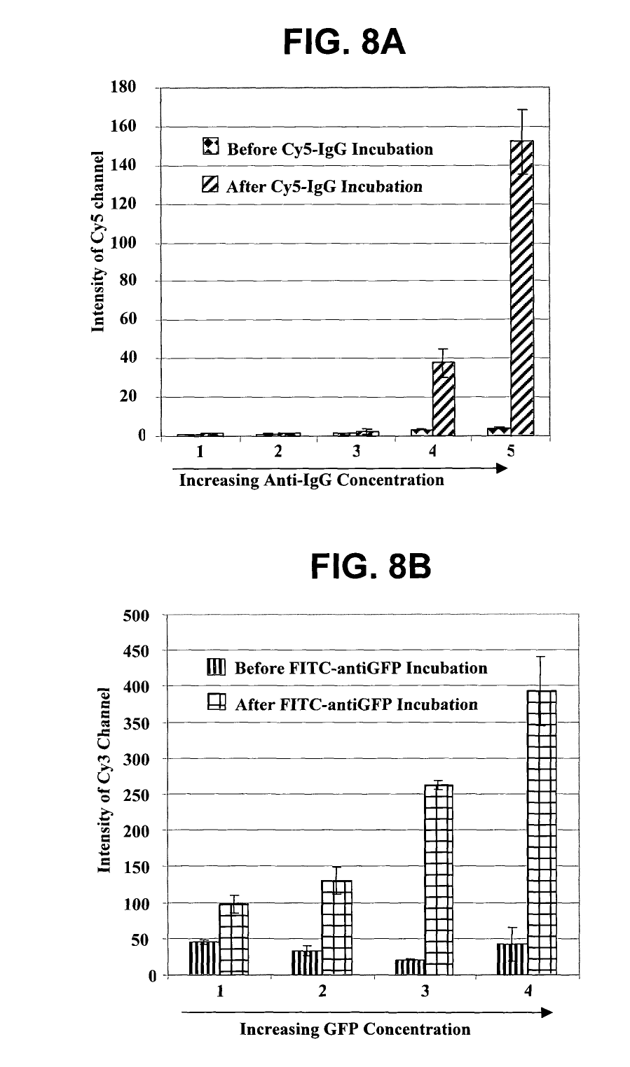

FIG. 7 is a graph illustrating quantitative results of the response of Biotinylated BSA to FITC-Streptavidin re-incubation. From these data it can be seen that after BSA blocking, there is almost no signal. After the first FITC-Streptavidin incubation, the spot intensity (fluorescence intensity of the spots in the BSA arrays) increased significantly, and approximately accurately reflecting the amount of Biotinylated BSA immobilized on the substrate. The intensity signal was decreased after the stripping process and increased after the second FITC-Streptavidin incubation. The spot intensities reflect the amount of biotinylated protein immobilized on the substrate of the glass slide.

The selectivity of microarrays of the present invention was confirmed by printing different concentrations of anti-IgG, biotinylated IgG and GFP onto a diazotized slide to form protein microarrays and then incubating the protein microarrays with Cy5-labeled IgG, FITC-Streptavidin and FITC-antiGFP, respectively.

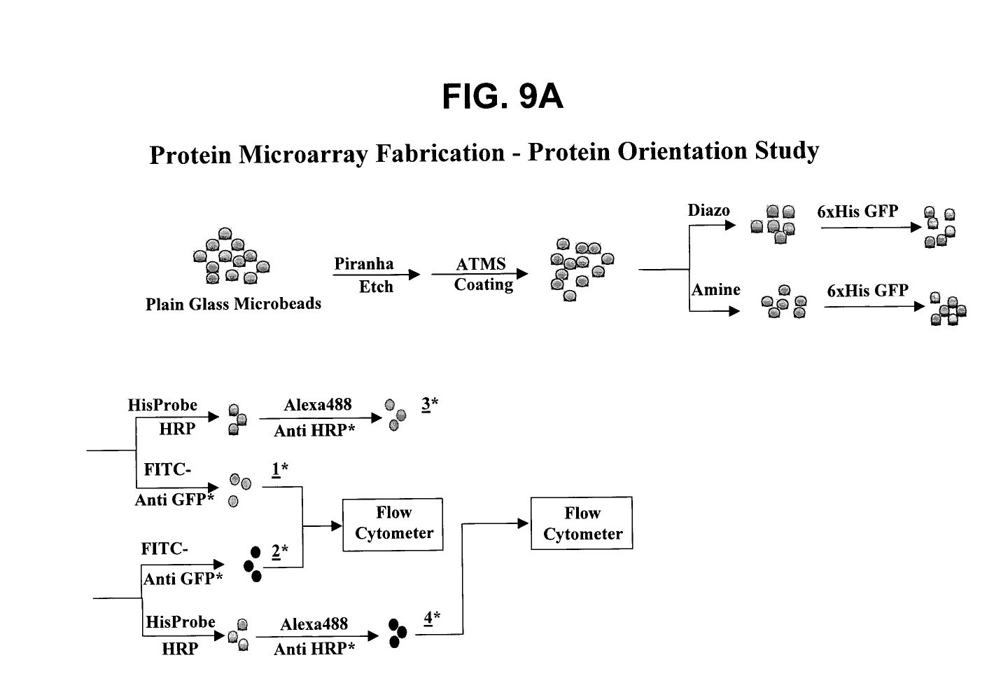

As shown in FIG. 8A, it can be seen that after the incubation of Cy5-IgG, increasing signal from anti-IgG was obtained corresponding to increasing concentrations of anti-IgG immobilized on the glass substrate. From FIG. 8B it can be seen that FITC-anti GFP will specifically bind to GFP spots only. Also, as discussed above with respect to FIG. 7, FITC-Streptavidin only binds to biotinylated BSA (not shown).

In contrast, there is no significant response between any of the unpaired antigen/antibody. These results prove that protein microarrays fabricated in accordance with the present invention have high binding selectivity and allow for the quantitative analysis of the binding of biomolecules such as antigen/antibodies to the protein arrays.

### EXAMPLE 4

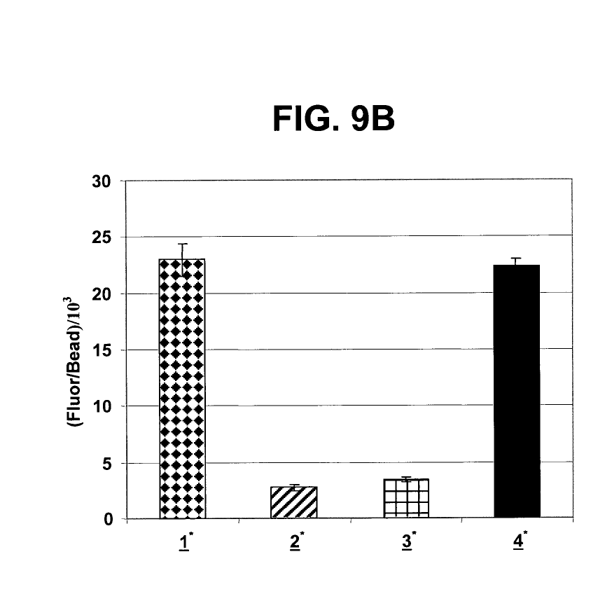

As illustrated in FIG. 9A, experiments were conducted to determine the orientation of microarrays formed by binding proteins having a terminal series of 6 histidine residues. The results of these experiments for each of four different groups of beads are shown in FIG. 9B.

Starting with piranha etching of plain glass microbeads, the beads were coated with ATMS. The surface of half the beads were diazotized in accordance with the present invention: groups 1 and 3 labeled “Diazo.” The other half of the beads were not diazotized, groups 2 and 4 labeled “Amine.” Both the Diazo and Amine beads were immobilized with 6×His-tagged GFP, after which half of the beads were incubated with FITC-anti GFP (groups 1 and 2) and detected by flow cytometer. Experimental results showed that diazotized beads (group 1) provided higher anti-GFP signal than the non-diazotized beads (group 2). These results, shown in the fluorescence graph of FIG. 9B, indicated that either more GFP had been captured onto the diazotized substrate or the immobilized GFP maintained higher activity on the diazotized substrate. GFP would maintain higher activity if the 6×His end of the 6His-tagged GFP preferentially bound to the diazotized substrate, allowing GFP to maintain its normal activity.

The other half of the beads (groups 3 and 4) were incubated with His-probe HRP, which reacted with the exposed histidine residue on the substrate, and was then detected by Alexa488-anti-HRP. Lower anti-HRP signal was detected with diazotized beads (group 3) than the non-diazotized beads (group 4). These results, shown in the fluorescence graph of FIG. 9B, indicated that although there is more active GFP immobilized on the diazotized substrate, there are fewer histidine residues exposed. This is consistent with the diazotized substrate binding the His-tagged end of the protein.

### EXAMPLE 5

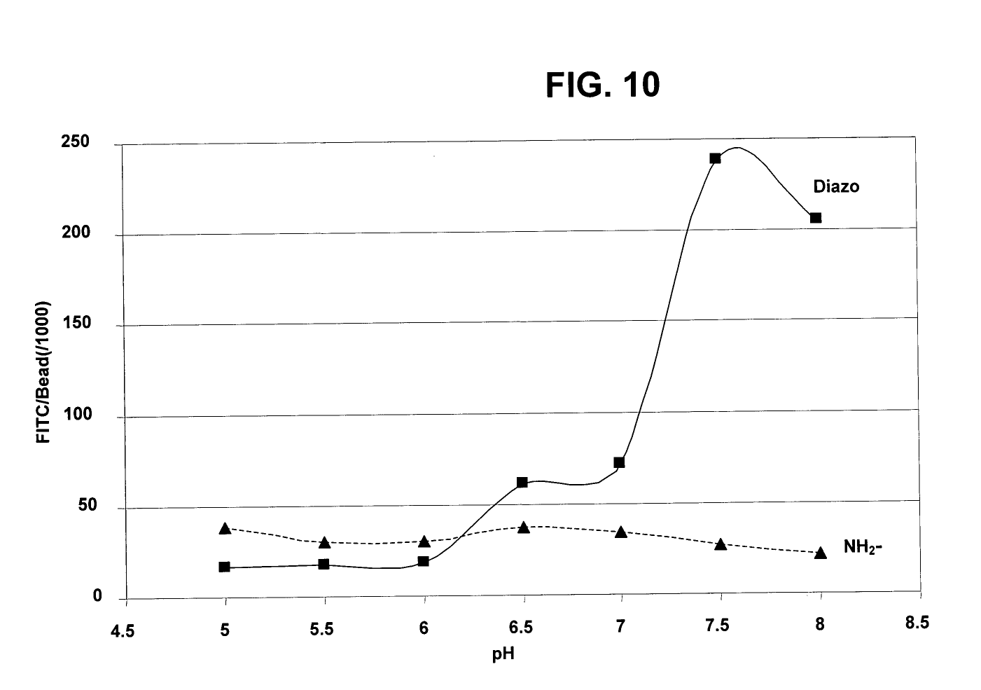

An experiment was conducted to determine the influence of pH on the binding of proteins with terminal histidine residues to diazonium and NH₂-terminated beads. Glass beads were coated with 6×His-tagged GFP at various pH values, with detection and level of binding being based on fluorescence of FITC-antiGFP. The results of this experiment are shown in the graph of FIG. 10. The graph of FIG. 10 illustrates that a higher amount of His-tagged GFP was immobilized to the diazotized substrate, when pH>pKₐ of histidine (˜6.0). Also, as can be seen from the line labeled “NH₂”, only limited amounts of 6×His-tagged GFP binds to the non-diazotized substrate, causing only limited amounts of 6×His-tagged GFP to be available to bind with FITC-antiGFP.

All documents, patents, journal articles and other materials cited in the present application are hereby incorporated by reference.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A microarray comprising:
a diazotized tether group bound to a substrate; and
at least one polypeptide covalently bound to said diazotized tether group.

2. The microarray of claim 1, wherein said polypeptide includes at least one terminal histidine residue.

3. The microarray of claim 2, wherein said polypeptide is covalently bound to said diazotized tether group at said at least one terminal histidine residue.

4. The microarray of claim 2, wherein said polypeptide includes a terminal series of 6 histidine residues.

5. The microarray of claim 4, wherein said polypeptide is covalently bound to said diazotized tether group at one of said histidine residues.

6. The microarray of claim 2, wherein said polypeptide includes a terminal series of up to 20 histidine residues.

7. The microarray of claim 6, wherein said polypeptide is covalently bound to said diazotized tether group at one of said histidine residues.

8. The microarray of claim 1, wherein said polypeptide is bound to said diazotized tether group by an internal histidine residue of said polypeptide.

9. The microarray of claim 1, wherein said polypeptide includes at least one terminal tyrosine residue.

10. The microarray of claim 9, wherein said polypeptide is covalently bound to said diazotized tether group at said terminal tyrosine residue.

11. The microarray of claim 9, wherein said polypeptide includes a terminal series of 6 tyrosine residues.

12. The microarray of claim 11, wherein said polypeptide is covalently bound to said diazotized tether group at one of said tyrosine residues.

13. The microarray of claim 9, wherein said polypeptide includes a terminal series of up to 20 tyrosine residues.

14. The microarray of claim 13, wherein said polypeptide is covalently bound to said diazotized tether group at one of said tyrosine residues.

15. The microarray of claim 1, wherein said polypeptide is bound to said diazotized tether group by an internal tyrosine residue of said polypeptide.

16. The microarray of claim 1, wherein said substrate comprises a glass substrate.

17. The microarray of claim 16, wherein said substrate comprises a glass bead.

18. The microarray of claim 14, wherein said substrate comprises a glass slide.

19. The microarray of claim 1, wherein said substrate comprises a polymer substrate.

20. The microarray of claim 19, wherein said substrate comprises a plastic substrate.

21. The microarray of claim 20, wherein said substrate comprises polyethylene terephthalate.

22. The microarray of claim 1, wherein said substrate comprises a silicon wafer.

23. The microarray of claim 1, wherein said substrate comprises a ceramic substrate.

24. The microarray of claim 1, wherein said substrate comprises a metal oxide substrate.

25. The microarray of claim 1, wherein said substrate comprises a clay substrate.

26. The microarray of claim 1, wherein said substrate comprises a noble metal substrate.

27. The microarray of claim 26, wherein said substrate comprises a gold substrate.

28. The microarray of claim 26, wherein said substrate comprises a silver substrate.

29. The microarray of claim 26, wherein said substrate comprises a copper substrate.

30. The microarray of claim 1, wherein said at least one polypeptide comprises a plurality of polypeptides.

31. The microarray of claim 30, wherein said plurality of polypeptides comprises at least two different polypeptides.

32. The microarray of claim 1, wherein said polypeptide comprises a protein.

33. The microarray of claim 1, wherein said substrate has a thickness of approximately 1 mm.

34. The microarray of claim 1, wherein said diazotized tether group comprises a siloxy diazonium group.

35. The microarray of claim 34, wherein said siloxy diazonium group comprises p-diazoniumphenyltrimethoxysilane salt.

36. The microarray of claim 1, wherein said diazotized tether group comprises a thiolate diazonium group.

37. The microarray of claim 34, wherein said thiolate diazonium group comprises p-diazoniumthiophenol salt.

38. A method for forming a microarray comprising:
(a) treating an oxidized surface of a substrate with a siloxy amine to form a siloxy amine treated substrate;
(b) treating said siloxy amine treated substrate with a diazotizing agent to form a siloxy diazotized substrate; and
(c) contacting said siloxy diazotized substrate with at least one polypeptide to form said microarray in which said at least one polypeptide is covalently bound to said siloxy diazotized substrate.

39. The method of claim 38, wherein said polypeptide includes at least one terminal histidine residue.

40. The method of claim 39, wherein said polypeptide is covalently bound to said siloxy diazotized substrate at said at least one terminal histidine residue.

41. The method of claim 38, wherein said polypeptide includes a terminal series of 6 histidine residues.

42. The method of claim 41, wherein said polypeptide is covalently bound to said siloxy diazotized substrate at one of said histidine residues.

43. The method of claim 39, wherein said polypeptide includes a terminal series of up to 20 histidine residues.

44. The method of claim 43, wherein said polypeptide is covalently bound to said siloxy diazotized substrate at one of said histidine residues.

45. The method of claim 38, wherein said polypeptide is bound to said siloxy diazotized tether group by an internal histidine residue of said polypeptide.

46. The method of claim 38, wherein said polypeptide includes at least one terminal tyrosine residue.

47. The method of claim 46, wherein said polypeptide is covalently bound to said siloxy diazotized substrate at said terminal tyrosine residue.

48. The method of claim 46, wherein said polypeptide includes a terminal series of 6 tyrosine residues.

49. The method of claim 48, wherein said polypeptide is covalently bound to said siloxy diazotized substrate at one of said tyrosine residues.

50. The method of claim 46, wherein said polypeptide includes a terminal series of up to 20 tyrosine residues.

51. The method of claim 50, wherein said polypeptide is covalently bound to said siloxy diazotized substrate at one of said tyrosine residues.

52. The method of claim 38, wherein said polypeptide is bound to said siloxy diazotized tether group by an internal tyrosine residue of said polypeptide.

53. The method of claim 38, wherein said siloxy amine comprises p-aminophenyl trimethoxysilane (ATMS).

54. The method of claim 38, wherein said diazotizing agent comprises NaNO₂ and HCl.

55. The method of claim 38, wherein said siloxy diazotized substrate is formed from said siloxy amine treated substrate by exposing said siloxy amine treated substrate with NaNO₂ and at 0-25° C. for 10-30 minutes.

56. The method of claim 38, wherein said siloxy diazotized substrate is formed from said siloxy amine treated substrate by exposing said siloxy amine treated substrate with NaNO₂ and HCl at 0-4° C. for 30 minutes.

57. The method of claim 38, further comprising treating a substrate surface with an oxidizing agent to form said oxidized surface.

58. The method of claim 57, wherein said substrate comprises a polymer substrate.

59. The method of claim 58, wherein said substrate comprises a plastic substrate.

60. The method of claim 59, wherein said substrate comprises polyethylene terephthalate.

61. The method of claim 38, wherein said siloxy diazotized substrate comprises a glass substrate.

62. The method of claim 61, wherein said siloxy diazotized substrate comprises a glass bead.

62. The method of claim 61, wherein said siloxy diazotized substrate comprises a glass slide.

63. The method of claim 38, wherein said siloxy diazotized substrate comprises a polymer substrate.

64. The method of claim 63, wherein said siloxy diazotized substrate comprises a plastic substrate.

65. The method of claim 64, wherein said siloxy diazotized substrate comprises polyethylene terephthalate.

66. The method of claim 38, wherein said siloxy diazotized substrate comprises a silicon wafer.

67. The method of claim 38, wherein said siloxy diazotized substrate comprises a ceramic substrate.

68. The method of claim 38, wherein said siloxy diazotized substrate comprises a clay substrate.

69. The method of claim 38, wherein said siloxy diazotized substrate comprises a p-diazoniumphenyltrimethoxysilane salt bound to said substrate.

70. The method of claim 38, wherein said at least one polypeptide comprises a plurality of polypeptides.

71. The method of claim 70, wherein said plurality of polypeptides comprises at least two different polypeptides.

72. The method of claim 38, wherein said polypeptide comprises a protein.

73. The method of claim 38, wherein said substrate has a thickness of approximately 1 mm.

74. The method of claim 38, further comprising repeating step (c) one or more times and removing free polypeptides from said microarray after every time step (c) is performed without removing bound polypeptides from said microarray.

75. The method of claim 74, wherein each time step (c) is performed a different polypeptide is bound to said substrate.

76. A method for forming a microarray comprising:
treating a noble metal substrate with a thiolate amine to form a thiolate amine treated substrate;
treating said thiolate amine treated substrate with a diazotizing agent to form a thiolate diazotized substrate; and
contacting said thiolate diazotized substrate with at least one polypeptide to form said microarray in which said at least one polypeptide is covalently bound to said thiolate diazotized substrate.

77. The method of claim 76, wherein said polypeptide includes at least one terminal histidine residue.

78. The method of claim 77, wherein said polypeptide is covalently bound to said thiolate diazotized substrate at said at least one terminal histidine residue.

79. The method of claim 77, wherein said polypeptide includes a terminal series of 6 histidine residues.

80. The method of claim 79, wherein said polypeptide is covalently bound to said thiolate diazotized substrate at one of said histidine residues.

81. The method of claim 77, wherein said polypeptide includes a terminal series of up to 20 histidine residues.

82. The method of claim 81, wherein said polypeptide is covalently bound to said thiolate diazotized substrate at one of said histidine residues.

83. The method of claim 76, wherein said polypeptide is bound to said thiolate diazotized tether group by an internal histidine residue of said polypeptide.

84. The method of claim 76, wherein said polypeptide includes at least one terminal tyrosine residue.

85. The method of claim 84, wherein said polypeptide is covalently bound to said thiolate diazotized substrate at said terminal tyrosine residue.

86. The method of claim 84, wherein said polypeptide includes a terminal series of 6 tyrosine residues.

87. The method of claim 86, wherein said polypeptide is covalently bound to said thiolate diazotized substrate at one of said tyrosine residues.

88. The method of claim 84, wherein said polypeptide includes a terminal series of up to 20 tyrosine residues.

89. The method of claim 88, wherein said polypeptide is covalently bound to said thiolate diazotized substrate at one of said tyrosine residues.

90. The method of claim 76, wherein said polypeptide is bound to said thiolate diazotized tether group by an internal tyrosine residue of said polypeptide.

91. The method of claim 76, wherein said thiolate amine comprises 4-aminothiophenol.

92. The method of claim 76, wherein said diazotizing agent comprises NaNO₂ and HCl.

93. The method of claim 76, wherein said thiolate diazotized substrate is formed from said thiolate amine treated substrate by exposing said thiolate amine treated substrate with NaNO₂ and HCl at 0-25° C. for 10-30 minutes.

94. The method of claim 76, wherein said thiolate diazotized substrate is formed from said thiolate amine treated substrate by exposing said thiolate amine treated substrate with NaNO₂ and HCl at 0-4° C. for 30 minutes.

95. The method of claim 76, wherein said thiolate diazotized substrate comprises a gold metal substrate.

96. The method of claim 76, wherein said thiolate diazotized substrate comprises a silver metal substrate.

97. The method of claim 76, wherein said thiolate diazotized substrate comprises a copper substrate.

98. The method of claim 76, wherein said thiolate diazonium substrate comprises a p-diazoniumthiophenol salt bound to said substrate.

99. The method of claim 76, wherein said at least one polypeptide comprises a plurality of polypeptides.

100. The method of claim 99, wherein said plurality of polypeptides comprises at least two different polypeptides.

101. The method of claim 76, wherein said polypeptide comprises a protein.

102. The method of claim 76, wherein said thiolate diazotized substrate has a thickness of approximately 1 mm.
